(19) United States
(12) Patent Application Publication
(10) Pub. No.: US 2009/0008479 A1
(43) Pub. Date: Jan. 8, 2009

(54) AEROSOL CAN EXTENSION

(75) Inventor: George T. Domizio, Stevenson, CT (US)

Correspondence Address: BACHMAN & LAPOINTE, P.C., 900 CHAPEL STREET, SUITE 1201, NEW HAVEN, CT, 06510, US

(73) Assignee: OXFORD TECHNOLOGIES, Stevenson, CT (US)

(21) Appl. No.: 12/100,576

(22) Filed: Apr. 10, 2008

Related U.S. Application Data
(60) Provisional application No. 60/910,963, filed on Apr. 10, 2007.

(51) Int. Cl. B05B 15/06

(52) U.S. Cl. 239/532

(57) ABSTRACT

A spray container extension apparatus includes a housing structure for receiving a spray container, a trigger which can be hinged to the housing for causing a spray from a container in the housing, and an extension member preferably having an product tube sized properly for receiving and carrying spray from the container to a point of desired application, and a structural support member which rigidly supports the product tube to allow better control of spray through the extension member, and to maintain structural stability in horizontal and upwardly extending positions.

### BACKGROUND OF THE INVENTION

The invention relates to spray containers and, more particularly, to an apparatus for enhancing the use of such articles.

Spray containers such as aerosol cans, spray bottles and the like are widely used for various liquid products such as oils, pesticides, cleaners, polish, paint and the like. Locations of use of such products are not always in locations which are easy to reach. When this happens, there is a tendency to either over apply the product in terms of quantity and/or the area to which the product is applied, or skip use of the product altogether.

In the field of concrete molding, the molds or forms frequently must be lubricated before and/or after use. Typical lubrication comes in an aerosol powered spray can. The inner surfaces of the mold can be very difficult to reach, however, and therefore the lubrication can be either far over-done or skipped altogether.

Similarly, pesticides can at times be needed in hard to reach locations. For example, bee nests can be located high in trees or at elevated locations of buildings or other structures.

Numerous other uses of liquid products in pressurized containers exist, each with corresponding areas of use which are difficult to reach.

One lubricant manufacturer packages cans of lubricant with a short tube which can be used to focus the spray of lubricant. This tube helps in specific types of applications but leaves many other needs unanswered.

It is the primary object of the present invention to respond to these needs.

### SUMMARY OF THE INVENTION

The foregoing object has been attained by the present invention, which relates to an apparatus for extending the spray from a spray container. The apparatus includes a housing structure for receiving a spray container, a trigger which can be hinged to the housing for causing a spray from a container in the housing, and an extension member preferably having an product tube sized properly for receiving and carrying spray from the container to a point of desired application, and a structural support member which rigidly supports the product tube to allow better control of spray through the extension member, and to maintain structural stability in horizontal and upwardly extending positions.

The product tube also preferably has a threaded end and a valve adapter. The valve adaptor can be substituted for the normal valve on the spray container, and the threaded end connected into the adaptor to communicate the inner tube with the spray container as desired.

The length of the product tube and support member can be adjustable to allow for different lengths.

### BRIEF DESCRIPTION OF THE DRAWINGS

A detailed description of preferred embodiments of the present invention follows, with reference to the attached drawings, wherein:

FIG. 1 is a side view of an apparatus according to the invention;

FIG. 2 is an enlarged partially sectional view of the extension portion of the apparatus of FIG. 1;

FIG. 3 is an enlarged partially sectional view of the valve adaptor portion of the apparatus of FIG. 1;

FIG. 4 is a further view of a valve adaptor according to the invention;

FIG. 5 is an enlarged view of one embodiment of a trigger member according to the invention;

FIG. 6 illustrates a further embodiment of the invention wherein the extension portion has an adjustable length;

FIGS. 7 and 8 illustrate a further embodiment of the invention wherein the product tube is external of the support member and held relative to the support member by a series of clips; and

FIG. 9 illustrates an alternate embodiment wherein the nozzle has a swiveling end for controlling the direction of the stream to be sprayed.

### DETAILED DESCRIPTION

The invention relates to a spray container extension apparatus which can be attached to spray containers, especially aerosol powered cans, to provide a spray extender for delivering the product at a distant location.

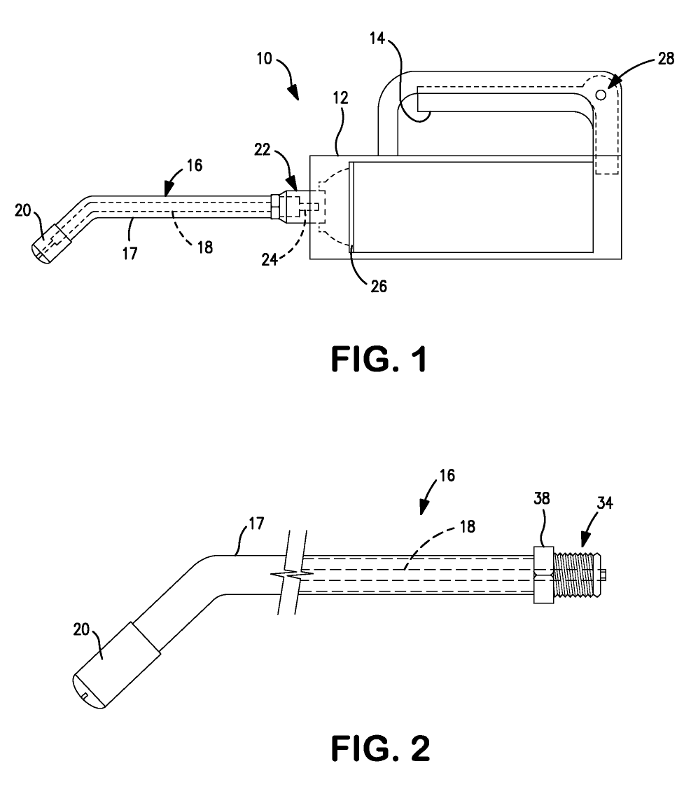

FIG. 1 shows one embodiment of a spray container extension apparatus 10 according to the invention. In this embodiment, apparatus 10 has a housing 12, a trigger 14, and an extension 16 which preferably includes a product carrying tube 18, a spray nozzle 20 and an adaptor structure 22 for connecting to the valve stem 24 of a typical spray container such as an aerosol powered can 26. These components, and their interaction and function, are discussed further below.

Housing 12 serves a basic function of holding the spray container and supporting extension 16 and trigger 14 relative to the spray container. To this end, housing 12 preferably has a shape which is suitable for receiving the spray container. In the embodiment of FIG. 1, the container is an aerosol powered spray can, and so housing 12 is generally cylindrical in shape. Housing 12 can be a full cylinder, to totally enclose the can if desired, or can be portions of a cylinder, preferably sufficient to structurally enclose and stabilize the spray can, but with portions open to allow identification of the can mounted within, and also to save materials.

Trigger 14 in this embodiment is a structure which is pivotably mounted to housing 12 at a hinge 28 to allow squeezing of trigger 14 and pivot of trigger 14 relative to housing 12 by the fingers of a hand used to carry the device. It should be appreciated that trigger 14 can be positioned relative to housing 12 in numerous different ways, and that the structure shown in FIG. 1 is merely one illustrative example. The key function of trigger 14 is to cause depression of the spray stem of the can when desired, and numerous different mechanical approaches can be taken to accomplish this, all within the broad scope of the present invention. One embodiment of trigger 14 is further illustrated and described below.

Extension 16 according to the invention includes a support structure 17 and a product tube 18. Support structure 17 can be a substantially rigid structure which will support its own weight and the weight of product tube 18, carrying product, when positioned into horizontally and or upwardly extending positions. Support structure 17 can be made from numerous suitable materials, such as various plastics, metal and the like. In the embodiment of FIG. 1, support structure 17 is a simple tube which is mounted to housing 12 at one end, and which has a nozzle 20 at the other which is communicated with product tube 18 and which has a configuration which is well known to persons of skill in the art. The configuration of nozzle 20 is generally adapted to specific types and uses of product, and can be adjustable to different types of spray.

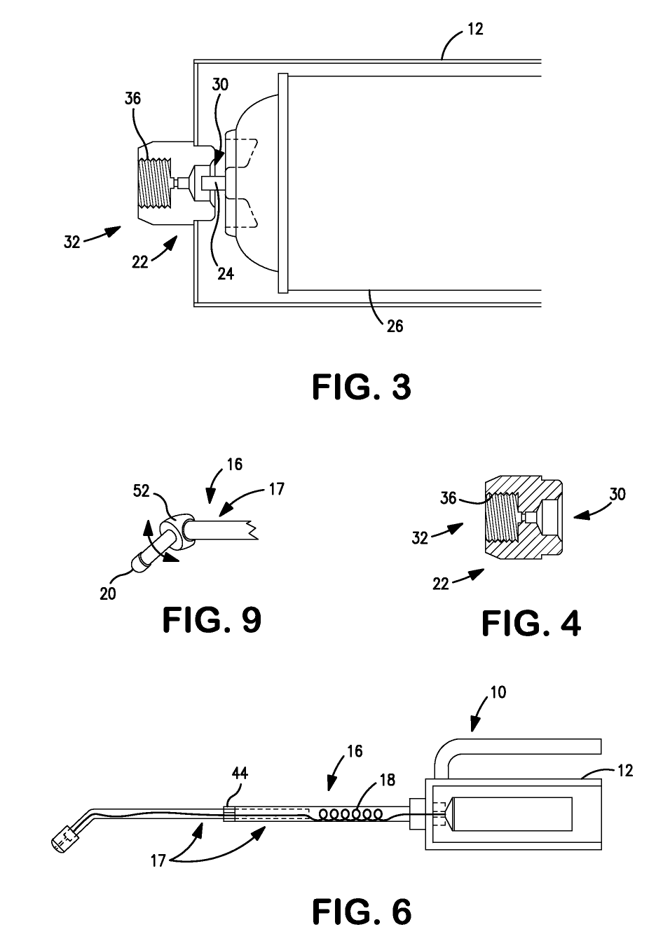

At the point of connection of extension 16 to housing 12, it should be appreciated that support structure 17 is preferably substantially rigidly mounted relative to housing 12, while product tube 18 is preferably communicated with the valve stem of the can to carry product when desired. According to the invention, a valve adaptor 22 is preferably provided and substituted on the can for the original and conventional spray nozzle. As is well known to the person of skill in this art, the conventional spray nozzle can typically be removed from the can leaving just the valve stem of the can, and adaptor 22 according to the invention is positioned over the valve stem of the can. Valve adaptor is also fixed relative to housing 12 such that valve adaptor immobilizes the valve stem of the can relative to housing 12. This is illustrated in FIG. 3 as a simple frictional engagement between adaptor 22 and housing 12, but could be further stabilized with a thread on collar or the like to hold valve adaptor in place.

Valve adaptor preferably has a can-facing side 30 and a tube facing side 32. Can facing side 30 is preferably profiled to receive the valve stem of a can, and preferably to leave room between side 30 and the can to allow some movement of the can relative to adaptor 22. This allows the movement which will be caused by trigger 14 to release product from within the can into the product tube 18.

Tube facing side 32 preferably is adapted to connection with the support structure 17. Referring to FIG. 2, support structure 17 is shown having a threaded end 34 which is adapted for connection into adaptor 22, for example by engaging with threads 36 of adaptor 22. A torquing surface 38 can also be provided on support structure 17 as shown in FIG. 2 to facilitate tightening of support structure 17 into adaptor 22 as desired.

FIG. 4 further illustrates the structure of adaptor 22 according to the invention.

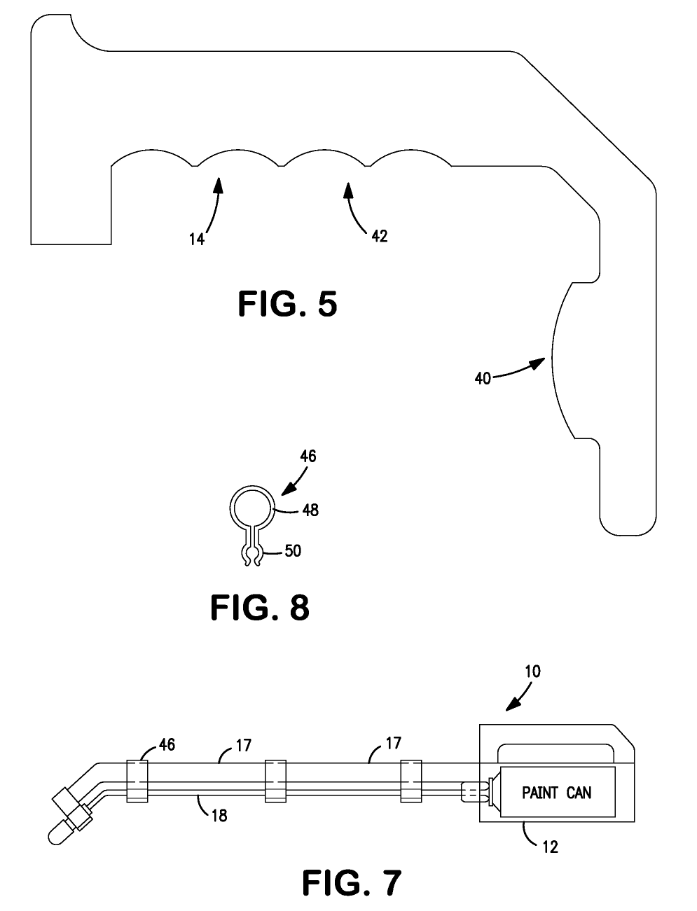

Turning to FIG. 5, an enlarged and more detailed illustration of trigger 14 is provided. As shown, trigger 14 can advantageously have a can engaging surface 40 which can have a rounded shape as shown. This shape is selected to substantially match the expected shape of the bottom portion of a can. Further, this surface 40 can advantageously be adjustable in its location, so that trigger 14 can be adapted to interact with cans of different height. Finger grip portions 42 can also be positioned along certain locations of trigger 14 as shown.

The structure of housing 12 and trigger 14 as illustrated herein should be appreciated as being a simple and reliable structure for receiving and operating spray containers of various different sizes and shapes. Further, as set forth above, trigger 14 as shown in FIG. 5 would be hingedly mounted to housing 12 as shown in FIG. 1. While this is one preferred embodiment of the invention, it should also be appreciated that housing 12 and trigger 14 can be mounted to each other and/or interact in numerous other ways.

FIG. 6 shows a further view of an apparatus 10 according to the invention wherein extension 16 is itself adjustable in length. In this embodiment, support structure 17 can be a telescoping structure, for example having a tightening collar 44 as shown, and product tube 18 can have a flexible and/or coiled portion which can extend and retract along with support structure 17. Various structures for making support structure 17 extendible are known to persons skilled in the art.

FIG. 7 shows an alternative embodiment of support structure 17 which, in this embodiment, is a substantially rigid member that supports product tube 18 through a series of clips 46. Clips 46 are further illustrated in FIG. 8, and are shown having a large radius portion 48 for engaging support structure 17, and a small radius portion 50 for engaging product tube 18. This support structure can be made of plastic or aluminum, or any other suitable material. Product tube 18 in this embodiment is more readily accessible than it is in the embodiment of FIG. 1, and this can be desirable for applications where tube 18 must be changed and/or cleaned often. One example of such an application is when the material to be applied is paint. Of course, other applications could likewise make advantageous use of the embodiment of FIGS. 7 and 8.

Finally, FIG. 9 illustrates a further alternative embodiment of the invention wherein extension 16 has a swivel connection 52 between support structure 17 and nozzle 20 so that nozzle 20 can be positioned at different angels with respect to structure 17 to help direct the spray as desired. Connection 52 can be any of numerous different structures which are known for use in providing a swivel motion to a support carrying a flexible tube. Such structures can have, for example, either structure which can be tightened or locked in a desired position, and/or a portion of extension 17 can be made from material which either structurally or materially holds a position to which it is manipulated. The exact structure of such a connection forms no part of the present invention, but incorporating such a structure into the apparatus of the present invention is considered to be one preferred embodiment of the invention.

Apparatus 10 in use allows numerous types of spray products to be conveniently applied at extended or distant locations. This can be particularly useful in numerous applications, and presents a solution to the need as outlined above.

It should be appreciated that while materials are identified for certain components of the present invention, each component can be made from a wide variety of suitable materials, with the important factors being sufficient structural strength, compatibility with the product being applied, manufacturing concerns and cost, among others.

It should also be appreciated that the above detailed description is made to describe an exemplary embodiment of the invention, and that numerous modifications would become readily apparent to a person of ordinary skill in the art, well within the broad scope of the present invention.

1. A spray extension apparatus, comprising:
a housing adapted for receiving a spray container;
a trigger positioned relative to the housing for actuating spray from a spray container in the housing; and
an extension member mounted to the housing and communicated with the spray container for carrying product to a location spaced from the spray container.

2. The apparatus according to claim 1, further comprising an adaptor member adapted to communicate with the valve stem of a spray container.

3. The apparatus according to claim 2, wherein the extension member comprises a product tube and wherein the product tube is communicated with the spray container through the adaptor member.

4. The apparatus according to claim 1, wherein the extension member comprises a structural support and a product tube supported by the structural support.

5. The apparatus according to claim 4, wherein the product tube is mounted inside the structural support.

6. The apparatus according to claim 4, wherein the product tube is mounted outside the structural support.

7. The apparatus according to claim 6, wherein the product tube is mounted to the structural support through a plurality of clips.

8. The apparatus according to claim 7, wherein each clip defines a first engagement zone having a radius selected to match the structural support, and a second engagement zone having a radius selected to match the product tube.

9. The apparatus according to claim 1, wherein the extension member is adjustable in length.

10. The apparatus according to claim 4, wherein the extension member further comprises a nozzle at a distal end of the extension member, and wherein the product tube is connected to the nozzle.

11. The apparatus according to claim 10, wherein the nozzle is connected to the extension member through a swivel connection.
